(19) United States
(12) Patent Application Publication
(10) Pub. No.: US 2009/0245542 A1
(43) Pub. Date: Oct. 1, 2009

(54) Automated recording facility

(76) Inventors: Michael Vasinkevich, Great Neck, NY (US); Chris Stean Olsen, Forest Hills, NY (US)

Correspondence Address: MAIER & MAIER, PLLC, 1000 DUKE STREET, ALEXANDRIA, VA, 22314, US

(21) Appl. No.: 12/078,506

(22) Filed: Apr. 1, 2008

(51) Int. Cl. H04R 3/00

(52) U.S. Cl. 381/122

(57) ABSTRACT

An automated recording facility and method of recording may include a potable booth enclosing an interior space with an exterior shell. A processor may be enclosed within the booth and the processor may communicate with an audio recording system. A hard drive, an audio device and a system interface may all be connected to the processor and the system interface may receive selected input from a user to control the audio recording system. A user can enter the portable booth and select a musical work using the system interface. Then a user can record a first and second audio performance which can then be stored on a hard drive. Then the user can edit the first and second audio performances using the system interface and merge the first and second audio performances with the selected musical work using a track merging program stored on the hard drive. After completing the merger the user can transfer the merged audio performances onto a fixed medium and dispense the fixed medium.

### BACKGROUND

There are different types of audio and video recording systems in which a user is able to perform a song or other musical performance and receive a copy of their performance at the conclusion of recording. However, conventional systems are unable to emulate studio functionality, features, production quality, and provide users with functionality that can accommodate diverse recording tasks (not limited to karaoke, internal media, a single recorded performance, a single production of recorded performance, a single layer as opposed to a merged multi-layered recording composition, or basic editing features) in an efficient, automated, unattended, and simplified manner.

Thus, conventional recording and/or production systems are unable to deliver and/or emulate various recording-studio functionalities to achieve diverse and/or merged multi-layered recordings for audio/video production while also providing an automated and seamless system by which an average user can easily compose, edit, record, reproduce, and create merged multi-track composition(s) (a multi-layered composition) without the use of a studio engineer/attendant, complex interface and/or complex process.

### SUMMARY

An exemplary embodiment of an automated recording facility may include a portable booth enclosing an interior space with an exterior shell. A processor may be enclosed within the booth and the processor may communicate with an audio and video recording system. A hard drive, an audio device and a system interface may all be connected to the processor and the system interface may receive selected input from a user to control the audio recording system.

An exemplary embodiment of a method of recording may include entering a portable booth and selecting a musical work using a system interface. Then a user can record a first and second audio performance which can then be stored on a hard drive. Then the user can edit the first and second audio performances using the system interface and merge the first and second audio performances with the selected musical work using a track merging program stored on the hard drive. After completing the merger the user can transfer the merged audio performances onto a fixed medium and dispense the fixed medium.

### BRIEF DESCRIPTION OF THE DRAWINGS

Advantages of embodiments of the automated recording facility will be apparent from the following detailed description of the exemplary embodiments thereof, which description should be considered in conjunction with the accompanying drawings in which like numerals indicate like elements, in which:

FIG. 1 is an exemplary perspective view of an automated recording facility.

FIG. 2 is an exemplary perspective view of another exemplary embodiment of an automated recording facility.

FIG. 3 is an exemplary perspective view of an exemplary component module used in an exemplary embodiment of the automated recoding facility.

FIG. 4 is an exemplary block diagram of an exemplary embodiment of an automated recording facility.

FIG. 5 is an exemplary block diagram of an exemplary embodiment of an automated recording facility.

FIGS. 6A-6B show a flow chart describing a recording process of an exemplary embodiment of an automated recording facility.

FIG. 7A-7D are exemplary flow charts describing an exemplary recording process of an embodiment of an automated recording facility.

FIG. 8 illustrates an exemplary screen shot of a menu displayed by an exemplary embodiment of an automated recording facility.

FIG. 9 illustrates an exemplary screen shot of a menu displayed by an exemplary embodiment of an automated recording facility.

FIG. 10 illustrates an exemplary screen shot of a menu displayed by an exemplary embodiment of an automated recording facility.

FIG. 11 illustrates an exemplary screen shot of a menu displayed by an exemplary embodiment of an automated recording facility.

FIG. 12 illustrates an exemplary screen shot of a menu displayed by an exemplary embodiment of an automated recording facility.

FIG. 13 illustrates an exemplary screen shot of a menu displayed by an exemplary embodiment of an automated recording facility.

FIG. 14 illustrates an exemplary screen shot of a menu displayed by an exemplary embodiment of an automated recording facility.

FIG. 15 illustrates an exemplary screen shot of a menu displayed by an exemplary embodiment of an automated recording facility.

FIG. 16 illustrates an exemplary screen shot of a menu displayed by an exemplary embodiment of an automated recording facility.

FIG. 17 illustrates an exemplary screen shot of a menu displayed by an exemplary embodiment of an automated recording facility.

FIG. 18 is an exemplary flow chart describing the auto-multi-track merge function of an exemplary embodiment of an automated recording facility.

FIG. 19 illustrates an exemplary screen shot of a menu displayed by an exemplary embodiment of an automated recording facility.

FIG. 20 illustrates an exemplary screen shot of a menu displayed by an exemplary embodiment of an automated recording facility.

FIG. 21 illustrates an exemplary screen shot of a menu displayed by an exemplary embodiment of an automated recording facility.

FIG. 22 is an exemplary flow chart describing a process of downloading/transmitting recordings created by an exemplary embodiment of an automated recording facility.

FIG. 23 illustrates an exemplary screen shot of a menu displayed by an exemplary embodiment of an automated recording facility.

FIG. 24 illustrates an exemplary screen shot of a menu displayed by an exemplary embodiment of an automated recording facility.

FIG. 25 illustrates an exemplary screen shot of a menu displayed by an exemplary embodiment of an automated recording facility.

FIG. 26 is an exemplary block diagram of an exemplary computer of an automated recording facility.

### DETAILED DESCRIPTION

Referring now to the drawings, wherein like reference numerals designate identical or corresponding parts throughout the several views.

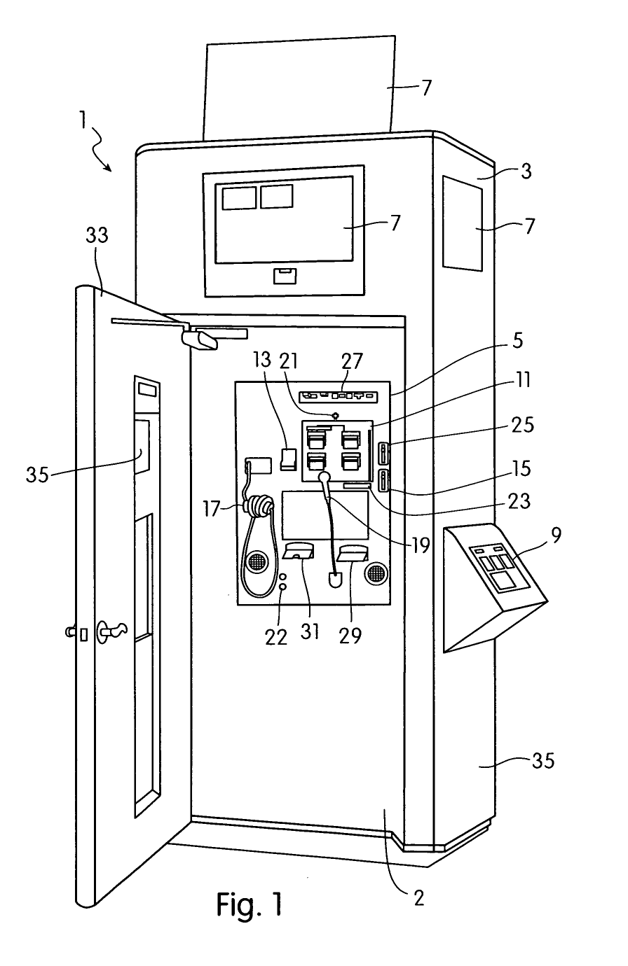

FIG. 1 is an exemplary perspective view of an exemplary embodiment of an automated recording facility. Details of the components and features of an exemplary embodiment of an automated recording facility 1 are shown and will be described with reference to FIG. 1. The automated recording facility 1 includes an interior portion 2 accessible by way of a doorway. Interior portion 2 may also be manufactured to a size providing enough space for any number of people to occupy the interior portion 2 at the same time, for example, from 1 to 3 people or more if desired. The overall dimensions and size of the facility 1 may also provide for portability and placement in a variety of different locations, for example, malls, street comers, inside businesses, or at any other desired locations.

A user of the facility 1 may enter the facility 1 and, by way of the controls and features of the software and hardware in the facility 1, is able to produce a studio quality audio and/or video production without the need for a studio engineer. As seen from the exterior of the facility 1, one or more external displays 7 may be visible to observers on the outside of the facility 1 who may either want to observe the conduct of a user inside the facility 1 or see other information presented on the display such as, for example, advertisements, descriptions of how the system operates, etc. External displays 7 may also include wrap-around screens that may be compatible with high definition sources, for example, liquid crystal displays, plasma displays or any other desired display.

A product information and song preview center 9 may also serve as a user interface for one or more of the external observers. These external observers may have the option of using a touch panel display on the preview center 9 to preselect potential songs, rhythms, beats, or other features that the observer may choose to use when it is that observer's time to enter the facility 1. The preview center 9 can include, for example, a touch panel display that provides for an interactive graphical user interface for two way communications with the facility 1. Optionally, a keyboard, keypad, or pointing device (e.g., mouse, track ball, etc.) may be used as an alternative to the touch panel display.

Another feature of the facility 1 is that it may be packaged as a portable device that may be delivered on site to different locations, for example, at a party or a corporate event. The facility 1 may be delivered by a rental service or leasing service for use at the temporary location for a limited period of time. Connections for both electrical and communication conductivity are provided through external connection ports on the facility 1. In remote locations, the facility 1 may be equipped to operate on battery power and may include wireless communication capability for providing conductivity at remote locations. Examples of wireless conductivity capabilities include cellular communications, radio frequency communications, microphone communications, infrared communications and space based digital communication services such as through the iridium service. Other connection possibilities include Wireless Local Area Networks (WLAN), IEEE 802.11 (WiFi), Wireless Metropolitan Area Networks (WMAN), and Broadband Fixed Access (BWA, IMDS, WiMax, and HIPERMAN).

The facility 1 may be used on portable platforms such as cruise ships, trains, etc., as entertainment services. Because the facility 1 may be a self-contained portable installation, the business uses of the facility 1 are widely diverse. It may enable a promoter, for example, to dispose the facility 1 at various locations, where the promoter is encouraging people from different geographical locations to submit audio and/or video recordings to another site where the recordings are aggregated and reviewed by the promoter. One example of such an operation is an event where amateur singers from different cities participate in a talent contest. Perhaps one month the promoter could have a set of the facilities 1 located in a first city, where different amateur users record multi-track recordings that are then submitted for review to the promoter. This way, during that month, the promoter may receive only talent submissions from amateurs at that particular city. The promoter then may review all the submissions and select a subset for use in the promoter's event. The following month, the same set of facilities 1, or a different set, may be deployed in a different city to gather the recordings of users in that second city.

As seen in FIG. 1, facility 1 may have an exterior shell 3 made from any one of a variety of materials. The facility 1 may include soundproof or sound dampening material used in the construction of the exterior shell 3. The material may include an outer metallic, or fiberglass layer, with sound insulating material on an interior side of the exterior material, followed by an interior panel made with sound absorbing properties. The facility 1 may have an interior portion, where the surface of the interior portion may have sound absorbing materials formed as a component shell 5.

Various components as will now be described may be mounted on, and integrated into, the interior component shell 5. However, as previously discussed with regard to FIG. 1, on the exterior shell 3 an external display 7 may be mounted thereon, so that observers who are not yet making recordings in the facility 1 may either view advertisements, instructions, or have a video of the user of the facility 1, or perhaps the original artist who sings the famous song being attempted by the user in the facility 1. Additionally, the interior surface of exterior shell 3 may have a green screen mounted thereon. This green screen may enable graphics, videos or any other desired background to be displayed and viewed by the user.

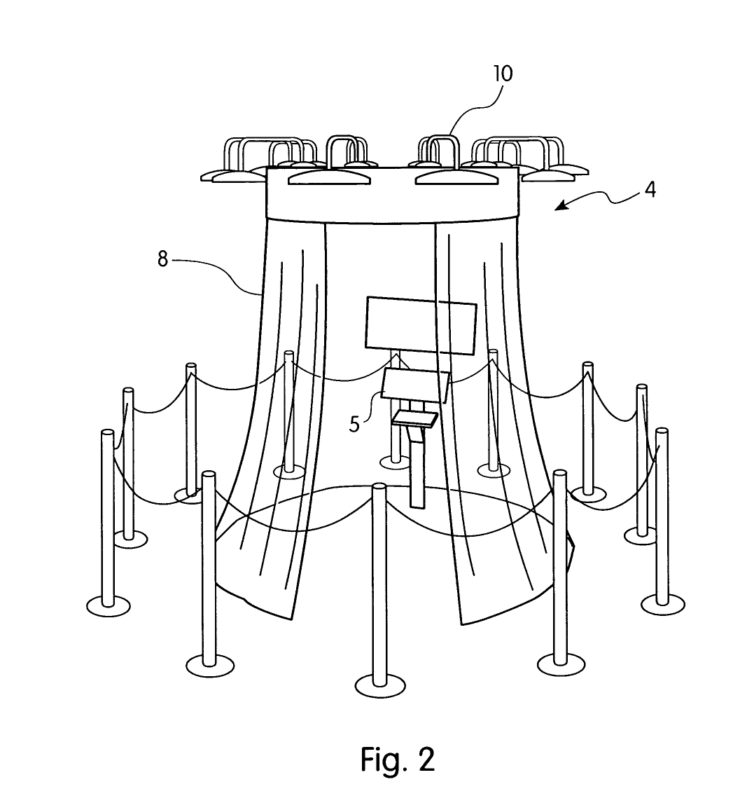

FIG. 2 shows another exemplary embodiment of a recording facility 4. Facility 4 may include an exterior shell 8 that may be formed of the same or similar material as exterior shell 3 shown in FIG. 1. Exterior shell 8 may also be formed in any desired shape or size. Exterior shell 8 may also be composed of LED screens, or any other electronic type screen that may be used to display advertisements, graphics or show any other desired ambience. These LED screens or similar electronic screens may be used to provide a visible barrier between the user inside the facility 4 and people outside the facility 4. The LED screens or similar electronic screens may have light weight and transparent properties and may be composed of a malleable or deformable material which may be positioned or adjusted in any desirable fashion. These LED screens or similar electronic screens may be made of, for example Martin LC40 or another desirable electronic screen product.

The cylindrical shape of the exterior shell 8, as shown in FIG. 2 may improve the visibility and visual appeal of images that may be shown on the LED screens or similar electronic screens integrated in exterior shell 8. Alternatively, the LED screens or similar electronic screens may also become transparent, at least partially, acting as a type of window allowing people outside the facility 4 to view the performance occurring within the facility 4. Additionally, the LED screens may be transparent to spectators surrounding the exterior of the facility 4, while simultaneously displaying images or graphics to a user inside the facility 4. The LED screens may also be configured for example, as windows, wrapped around substantially the entire exterior shell 8 or in any other desired configuration.

Additionally, exterior shell 8 may incorporate overhead lighting 10 which may be mounted to the exterior shell 8 in any desired configuration including for example, mounting the overhead lighting 10 to the top portion of the exterior shell 8 where the emitting light may shine down over the facility 4 and may improve the visibility of the LED screens or other features on the exterior of facility 4. Other performance recording hardware and software incorporated by facility 4 may be the same as that of recording facility 1. As seen in FIG. 2, the interior components and components shell 5 may have all of the same previously mentioned functionality and characteristics.

Product information and song preview center 9 can be located for example, in various different locations on the exterior shell 3 of the facility 1. The product information and song preview center 9 may be located at about waist height, or any other desired height, and may also be wheelchair accessible. The product information and song preview center 9 may allow a user to preliminarily view information such as songs and other capabilities that the system possesses. Also, a user can preselect information used in recording via the product information and song preview center 9. This speeds up the recording process by allowing preliminary information to be saved when the user is outside and another user is recording inside the facility 1. Thus, allowing more users to use the automated recording facility 1 in a given amount of time.

Located inside the facility 1 is a system interface 11. The system interface can be, for example, a touch screen, a keyboard, a track ball, or other means of input by which a user can control the automated recording facility 1. The system interface 11 may be approximately eye level when a user is standing and may display various means by which the user can control the automated recording facility 1 during the recording process. For example, the system interface 11 may include display screens by which the user can control the recording process.

Also located within the recording facility 1 may be a cash acceptor 13. The cash acceptor 13 may allow a user to pay for a recording session with currency. In addition to being able to pay for a recording session with currency, a user can pay for his or her session with a credit card. A credit card acceptor 15 may be located next to the system interface 11 or at any other location on the facility. It may allow a user to pay for a session conveniently by using their credit card or debit card. Headphones 17 may be located within the facility 1 and allow a singer to more clearly hear their performance and the background music they are singing to. Also, the headphones 17 may allow the user to block out extraneous noises while performing. Furthermore, using headphones 17 to monitor the recording (as opposed to using speakers) prevents the background music that is being monitored by the user from looping back through the microphone 19 (prevents feedback noise, and negative funnel-type effects on the recording). A microphone 19 may be included inside the facility 1 and may be highly adjustable in order to compensate for the various heights of different users. It is possible that the microphone 19 can be adjusted to a low setting so that a person in a wheelchair or a seated individual is able to record comfortably and with the microphone placed at an optimal position.

A camera 21 may also be located slightly above the system interface 11 or in any other desired location. The camera 21 may provide for the video recording of an individual performing inside the facility 1. Because the camera 21 may be located very close to the system interface 11, when a user reads lyrics displayed on the system interface 11, the eyes of the performer may be approximately at camera level. Thus, when a user performs, it may appear as though the performer is not reading off the screen but is rather looking straight into the camera. In addition to video recording via camera 21, still photographs may also be taken, using camera 21 or an additional camera, of the user at various desired times during a performance. Facility 1 may also include electronic inputs 22 for use with electronic instruments, for example, an electric guitar, for use by a user during a performance.

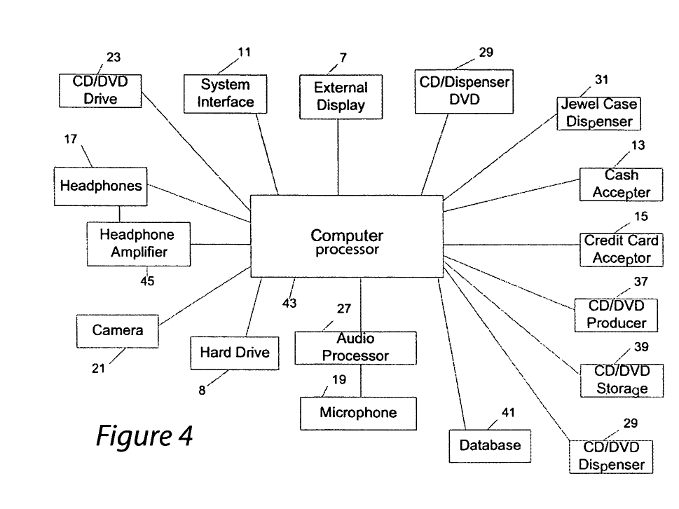

Also contained within the facility 1 and within the component shell 5 is a CD/DVD drive which allows a user to insert a CD or DVD with prerecorded information. The CD/DVD drive 23 may provide greater flexibility for a performer by allowing a user to access a song that may not be contained on a database 41 or hard drive 8 of the facility 1. External device inputs 25 are also included in the component shell 5 within the automated recording facility 1. External device inputs 25 allow a user to connect an external media device such as an iPod®, MP3 player, flash drive, or some other storage device to the automated recording facility 1. The external device inputs 25 can include USB connectors, IEEE 1394 connectors, Toslink connectors, RCA connectors, or other audio/data input connectors. An audio processor 27 is located in the component shell 5 and can provide a way for editing, mixing, and adjusting vocals for a performance taking place within the facility 1. The audio processor 27 communicates with a computer 43 as shown in FIG. 4. Further, the audio processor 27 allows for the adjustment of different frequencies, for example, bass frequencies and treble frequencies in order to customize a given performance.

After a user is done performing, one way in which the user can obtain a copy of their performance is by a CD/DVD dispenser 29. The CD/DVD dispenser 29 is located in the component shell 5 and allows for the production of a CD or DVD. Also located next to the CD/DVD dispenser 29 is a case dispenser 31, which allows for the production of a CD case. The CD case can be customized based on additional software that is operated by the system interface 11. Thus, the user can make custom CD or DVD cases that denote the user's recording performance. An embodiment of the automated recording facility may also utilize advanced robotics for CD/DVD production and dispensing. Specifically, robotics can be utilized for internally transferring recording media (CD/DVD) from mass storage areas to a CD surface printer, to production, and to the output bin. Robotics can also be used to print custom labels based on the user input, directly on the surface of a CD/DVD. In addition, the automated recording facility can have the ability to dispense custom CD/DVD cases, which help protect the finished product from debris or scratches.

The exterior shell 3 of the facility 1 may include a main door 33 which may swing outward and enable easy access to individuals going in and out of the facility 1, or alternatively, the door may also swing inward or open and close linearly in an accordion-type fashion. In addition, the main door 33 may open wide enough for a wheelchair to navigate into the facility 1. The main door 33 may include a window 35 or a plurality of windows. The windows 35 may be located on the main door 33 and may also located on the sides of the exterior shell 3. Windows 35 may allow individuals located outside of the recording facility 1 to view a performer inside of the facility 1. Thus, for example, a parent can keep an eye on young children while they are performing inside the booth. The windows 35 can also include automatic curtains that can be operated by the push of a button, or some other electronic device, to provide privacy to an individual recording within the facility 1. The automated curtains can be either shutters, blinds, fabric, or any other means by which the windows 35 can be covered. Another advantage of using windows 35 on the exterior shell 3 and door 33 is to reduce claustrophobia while still providing noise reduction characteristics.

Additionally, LED screens or similar electronic screens may be incorporated into the windows 35 or the exterior shell 3 and may be used to provide a visible barrier between the user inside the facility 1 and people outside the facility 1. These LED screens, or any other desired electronic type screen, may be used to display advertisements, graphics or show any other desired ambience. Alternatively, the LED screens or similar electronic screens may also become transparent, at least partially, acting as a type of window allowing people outside the facility 4 to view the performance occurring within the facility 1. Additionally, the LED screens may be transparent to spectators surrounding the exterior of the facility 1, while simultaneously displaying images or graphics to a user inside the facility 4. The LED screens may also be configured for example, as windows, wrapped around substantially the entire exterior shell 3 or in any other desired configuration.

The LED screens or similar electronic screens may have light weight and transparent properties and may be composed of malleable or deformable materials which may be positioned or adjusted in any desirable fashion. These LED screens or similar electronic screens may be made of, for example Martin LC40 or another desirable electronic screen product.

The exterior shell 3 can be made of a weather resistant material such as a metal, fiberglass, plastic, composite, or some other material which allows the exterior shell 3 to be impervious to the weather, thus allowing the facility 1 to be located outside, for example, at an amusement park, a fair, or some other outside event. The facility 1 may include a cooling/heating system inside of the facility 1 providing a comfortable environment by which a user can perform their recording and also providing a controlled environment when the facility 1 is located outside and not within a building.

The climate control system may be, for example, a heating, ventilation, and air-conditioning system (HVAC). The climate control system can be used to cool equipment and maintain a comfortable climate in the sealed booth, even if the booth is located outside and is exposed to the elements. The exterior panels and/or materials of the recording module can be made of materials that can withstand various vending environments: such as high-temperature conditions, low-temperature conditions, and rain/snow.

The interior of the recording module can have a cleared-floor design that allows a user to bring along musical instruments, accommodates multiple users, accommodates the handicapped, allows dancing while performing, and encourages standing while singing (providing a better vocal performance).

In addition, the recording facility 1 may contain wheels, or some other mechanism allowing the recording facility 1 to be easily transported. The facility 1 may also be made up of several separate components which can quickly and easily be assembled and disassembled.

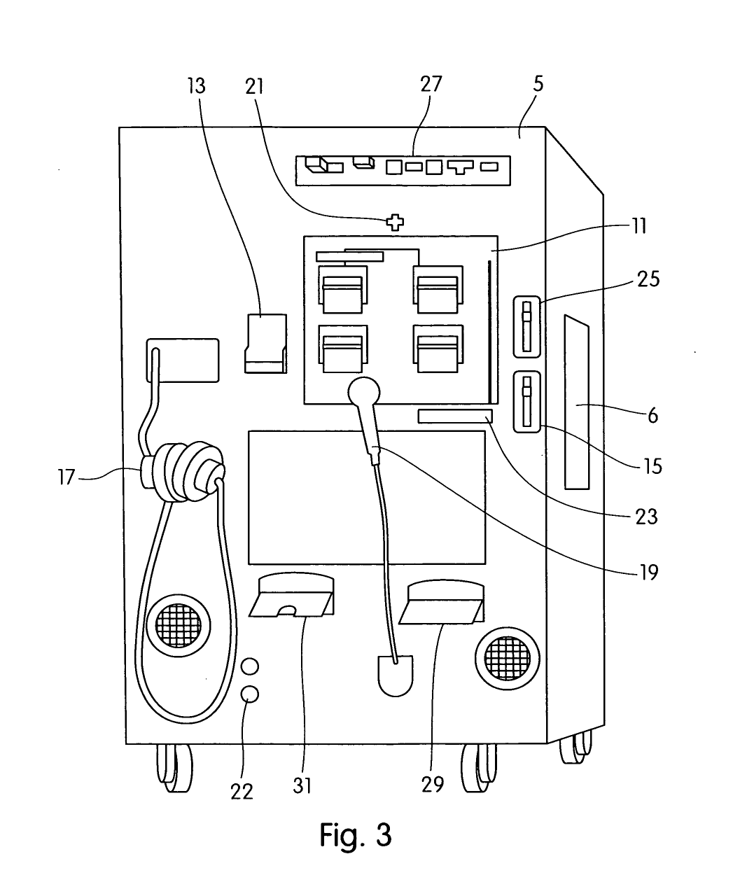

FIG. 3 is an exemplary perspective view of the component shell 5. FIG. 3 shows the component shell 5 removed from the exterior shell 3 and the inside of the automated recording facility 1. Because the component shell 5 can be easily removed from the rest of the facility 1, maintenance can easily be performed. If there is a malfunction, a maintenance technician can simply remove the component shell 5 from the exterior shell 3 and then put in a new component shell 5 in the exterior shell 3 on site, and then bring the malfunctioning component shell 5 to a repair facility for repair. Thus, the downtime associated with a malfunction of the automated recording facility 1 is minimized.

The component shell 5 may also reduce the need to diagnose problems at the vending-sites, and may reduce the need for specialized technicians on site. The component shell 5 may not require the exterior shell 3 in order to operate and may be functional as a stand alone unit. Also, it may be possible to insert the component shell 5 into some other shell or environment by which the component shell 5 can still fully function and operate. Also, the component shell 5 may contain a power/data interface 6 that may include audio/video input/output and computer/network/internet connections that may be used to connect the component shell 5 to the exterior shell 3 or directly to audio/video or network connections.

FIG. 4 is an exemplary diagram of the various components that may be connected to or contained within the facility 1. FIG. 4 shows different ways in which these components may be connected and communicate with each other. A computer processor 43 is shown in the middle of FIG. 4 and is connected to many of the different components used when operating the facility 1. The components shown in FIG. 4 could all be located within the component shell 5 or separated physically from component shell 5. Some of the components shown in FIG. 4 could be separately contained in the exterior shell 3 portion of the facility 1.

A system interface 11 may be connected to the computer processor 43. In addition, the external display 7 may be connected to the computer processor 43. A CD/DVD dispenser 29, a case dispenser 31, a cash acceptor 13 and the credit card acceptor 15 may all be connected to and communicate with the computer processor 43. A CD/DVD producer 37 shown in FIG. 4 may be used to burn the user's performance recording onto a CD or DVD. The CD/DVD producer 37 can burn a CD on a CD-R/CD-RW or a DVD-R, or DVD-RW. A CD/DVD storage device 39 communicates with the computer processor 43 and may contain blank recordable media and a robotic\transport mechanism to transfer the blank recordable media to the CD/DVD producer 37 where a CD or DVD is created with the user's recording on it. After the CD/DVD producer 37 has created a CD or DVD, the CD/DVD dispenser 29 and the case dispenser 31 may output the CD/DVD and an accompanying case to the user. The system may utilize the robotic\transport mechanism of the CD/DVD dispenser 29 and case dispenser 31 to convey the CD or DVD and case to the user, or alternatively the system may utilize some other means of conveyance.

Also shown in FIG. 4 is a database 41. The database 41 may be connected to the computer processor 43 and can contain songs, instrumentals, beats, or any other type of music or sounds that can be used in making a recording. The database 41 can communicate with processor 43 via a network or wirelessly. The database 41 could also be included within the automated recording facility 1. However, an advantage of having the database 41 located in a different location than the facility 1 is that an increased amount of information can be stored remotely, while reducing the size of the automated recording facility 1. It is also envisioned that multiple databases 41 could be connected to the computer processor 43.

The database 41 could also be used as a storage unit where a user could store their completed recordings. Database 41 may include several hard drives that may enable a user to locally store information relating to a performance. For example, database 41 may include 2 main drives, such as RAID 3 Terabyte drives, and a backup drive, in order to provide for this local storage of information. Additionally, all performance information may be stored locally in full high definition for a pre-established time frame, for example, seven days or more. This can allow a user to return to the facility 1 at a later time to download their recordings and this may also reduce the need for the facility 1 or database 41 to have unnecessarily large storage capabilities on site. The database 41 may provide an alternative to producing a hard copy of their performance on a DVD or CD. For example, they could store their recording on the database 41 and then login to the database via a website, access their saved recording, and upload their recording to their personal computer at home (or some other device or location) in any of a variety of formats, such as lower definition MP4 format, through the use of a USB or some other desired input connection. Additionally, video and audio recordings stored on database 41 may be store in high definition and may be downloaded in a variety of different desired levels of quality, for example, full HD, dvd, cd, MP3, MP4 or any other desired level of quality.

Also connected to the computer processor 43 may be the audio processor 27. The audio processor 27 may be used to enhance the user's recording by providing editing features and can be used to adjust various parameters of a user's recording. For example, the user can adjust and boost different frequencies of a recording such as the treble, the midrange, or the bass frequencies. Also, a user can modify the pitch of the vocals, or slow down or speed up the playback rate of the recording.

The microphone 19 connects into the audio processor 27, which may in turn be connected to the computer processor 43. The camera 21 may also be connected to the computer processor 43. The computer processor 43 may be able to control the different functions of the camera 21 including, for example, the zoom of the camera's lens or the focusing of the camera's lens. The computer processor 43 may also control the camera's recording functions such as stop, record, rewind, and fast forward. Once a user has performed and has obtained a video recording of their performance, the computer processor 43 can manipulate the video data, or digital still image, to provide different backgrounds and different visual effects to a user's video recording or digital still image. Since the user is also able to create a multi-layered audio composition (using the auto-multi-track function) the user can also capture the multi-layered audio composition on the video recording (results in a video capture with audio characteristics that otherwise could not be achieved, or are difficult to achieve during a live video performance). The headphones 17 may be connected to a headphone amplifier 45, which may in turn connect to the computer processor 43. The headphone amplifier 45 may amplify the audio signal received from the computer processor 43 and send the signal to be reproduced to the headphones 17.

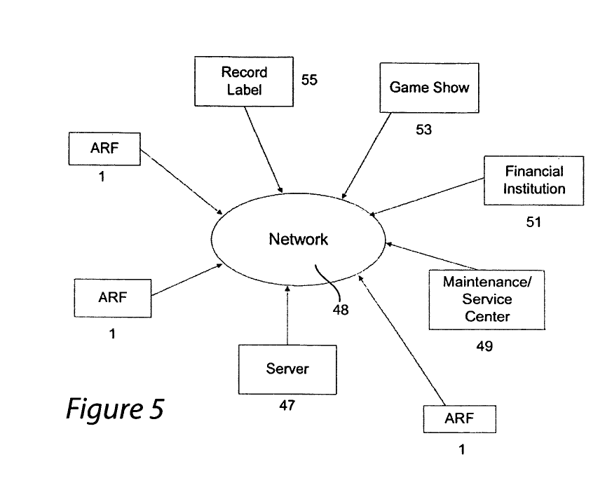

FIG. 5 shows an exemplary diagram of how various automated recording facilities 1 can interface with other entities and devices via a network. FIG. 5 shows multiple recording facilities 1 which can be located in various different locations. For example, one facility 1 could be located within a shopping mall and another facility 1 could be located at an amusement park in a different state. However, the multiple automated recording facilities 1 may be networked so that they can communicate with each other and/or can upload/download information to a common source or destination such as a server 47. Thus, even though several facilities 1 can be located in different locations, they can have access to the same information held on the server 47 via a network 48, allowing several different users of various recording facilities 1 located in different locations to submit musical compositions to the same place. For example, individuals competing in a talent show can record performances at different recording modules located throughout the country and submit performances to one common server electronically.

Also shown in FIG. 5 is a maintenance/service center 49. The maintenance/service center 49 may be connected to various facilities 1 via the network 48 and receives messages and error notifications relating to a particular facility 1. Also, the maintenance/service center 49 could send software updates to the facilities 1 over the network 48. The facilities 1 can send a message electronically to the service center 49 when there is a malfunction and then a technician can be dispatched to the location where the facility 1 is located. This can decrease the amount of time a recording facility 1 is inoperable by decreasing the amount of time it takes a technician to learn of the malfunction and thus reducing the amount of time it takes to make the repair.

Supervisory functions can also be managed by the automated recording facility 1. The automated recording facility 1 is capable of generating various reports that may be useful for monitoring maintenance issues. Thus, when there is a maintenance issue, management personnel in charge of the automated recording facility may be promptly notified, and a technician can be rapidly dispatched. Also, various types of data (e.g. income of the machine, statistics of usage, error reports, etc.) can be digitally retrieved from the system via the internet, or locally, by opening a password controlled supervisor panel and attaching a USB based mini-drive (or any other storage device) to the external device inputs 25. Maintenance personnel can then type in a password, and press a button to transfer the appropriate system-generated report to the storage device connected to the external device input 25. The password used to access the supervisor panel can be controlled by a variable-based password system (i.e. the password automatically changes periodically). Thus, the password may never the same with each attempt of opening the supervisor panel. For scheduled system maintenance, a password may be given/dispatched to maintenance personnel by the maintenance/service center 49 associated with the automated recording facility 1, and may work during a limited time frame.

The password may be generated at the maintenance/service center 49 using an automated recording facility management-software tool which can generate password codes based on the proper management-identity password, and required system information. The password may also be generated through any other desired method. The manner in which these password codes are generated can be concealed from management or any other person or entity. For example, if a maintenance employee is no longer employed by the owners of the automated recording facilities 1, the owner of the automated recording facilities 1 may not have to update the password because the password can change automatically. This variable-password process can improve system security, and also increase the likelihood of timely maintenance service (since maintenance passwords only work for a limited time). Furthermore, the supervisor panel can be accessed by other individuals who are not maintenance employees (e.g. users) who may call the maintenance/service center 49 to report problems with an automated recording facility 1. A password can then be given to activate restricted functionality in order to correct a system problem or to reactivate a disrupted user session. It is also possible that the password given to the user will only reactivate a recording session if certain system criteria are met. Thus, the password can prevent false claims made by users that the automated recording facility 1 is malfunctioning.

Also shown in FIG. 5 is a financial institution 51. The financial institution 51 can be, for example, PayPal®, a bank, or credit card company, etc. The financial institution 51 may provide other means by which a user can pay for their recording. For example, a user can access their PayPal® account via the system interface 11 and pay for their recording electronically via the Internet. A game show 53 can also be connected to the network and is another example of an entity in which a user can submit their recording to electronically. As mentioned earlier, for example, in a talent search, various competitors can record a composition in different locations of the country and then submit their recording electronically via the system interface 11 and transmit their recording to a common destination, such as a game show 53. A user may also transmit the recording over a network to a record label 55 or some other company in the music industry. Other businesses or components can also be linked to the automated recording facilities 1 via a network.

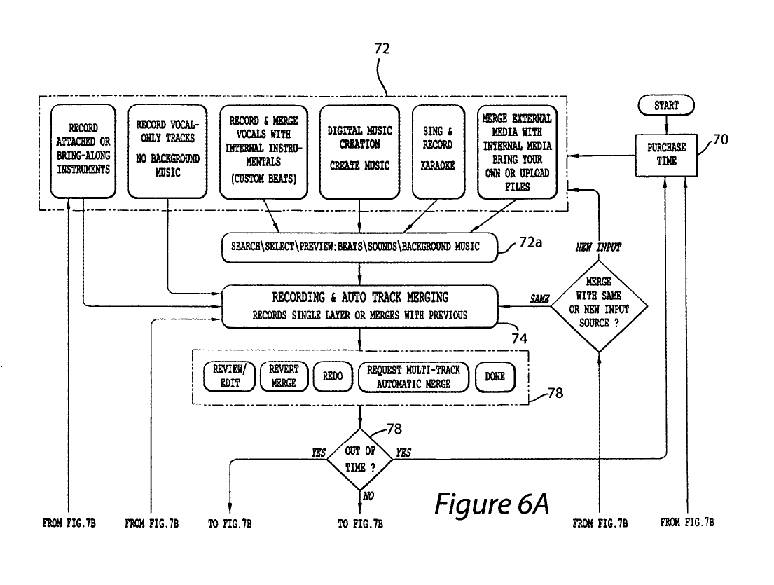

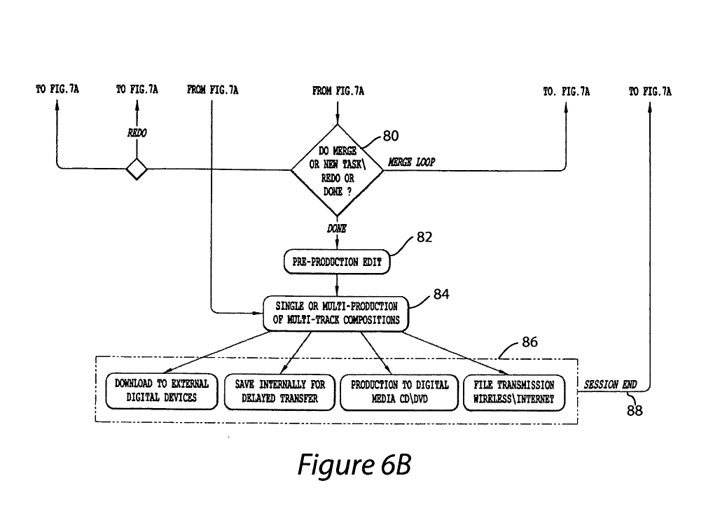

FIGS. 6A-6B show an exemplary flow chart of an exemplary process by which a user can produce a recording of their musical performance. The process may begin by a user purchasing recording time 70 by inserting money, a credit card, tokens, a prepaid password or code, etc., into the system. Next, the user may be presented with several recording options 72 based on their preferences. For example, a user can record an instrument that they have brought along with them such as a harmonica or guitar, or a user could record a vocal-only track (i.e., a cappella). A user may also record over internal system media, external media provided by the user, media that is downloaded from the internet to the system, or media that could be transferred into the system by other digital/wireless means. Regardless of the method used to transfer media into the system, the software used by the system may monitor incoming media and then allow the user to use and/or manipulate such media in the same or similar manner as internal media.

Accordingly, the system interface 11 may display a screen in which six options 72 are available (other options are possible) for the user based on the recording task they wish to perform (sing a cappella or perform a speech, sing karaoke, sing personal lyrics over custom beats (internal or external), record an instrument or record other performances or media over external media that is brought along via external devices, insertable media (CD\DVD),or downloaded into the system via the internet, wirelessly, file transfer means, etc.).

After a user has recorded a performance the user can use the auto-track merging function 74 (an automated process that may be simply triggered by pressing a button on the system interface 11) in which the user can put a new recording layer on top of the recording they just performed. For example, a user can play an instrument in the first recording and then with the auto track-merging feature 74 they can create a second recording where they add vocals to the previous instrumental recording. After a user has used the auto-track merging function 74, the user may have the option to review and use simplified auto-edit system features 76 to alter the recording just performed.

In addition, the user may have the ability to revert the merge and go back to their first or previous recording. For example, if the user created a first recording of instrumentals and then used the auto-multi-track-merge feature 74 to record vocals on top of the previously recorded instrumental track, the user could revert the merge if the merge was unsatisfactory and go back to the first recording which only contained instrumentals. The user can then try attempt the multi-tracked recording 74 another time. Accordingly, if the user approves of the auto track recording 74 after reviewing 76 their last recording, the user can request that the multiple-tracks are automatically merged 74. If the user merges the recording 74, both recordings are integrated and the resulting track will contain multiple layers of recordings in a single recording (merged multi-layered composition).

Next, once a user is done with the auto track-merge function 74, the system may determine whether or not the user has any recording time left 78. As long as the user has time remaining 78 in the recording session (or the user purchases additional time), the user can either continuously create other recording layers and merge 80 these new recording layers with the previously recorded multi-layered composition, or the user can advance to the pre-production edit step 82. In the pre-production edit step 82 the user can control what tracks will be included in the final production 86 of CD/DVD and/or transfer files to other devices or destinations (such as web sites/email). The user can preview and delete unwanted recordings before burning or finalizing the recording to a CD or DVD or requesting a file transfer.

After the pre-production edit step, the user can advance to the single or multi-production step 84. In this step, single or multiple copies of the actual physical disks may be produced with a recording encoded thereon. For example, the CD/DVD producer 37 may create a burned copy of the CD or DVD storing the user's recording on it. Also, the user can download their finished recording to external digital devices such as an MP3 player or a flash disk, etc. The facility 1 also has the capability of saving the finished recording internally on a hard drive, for example, in order to transfer the finished recording to another device or location at a later time. Further, the finished recording can be transmitted electronically over the Internet or by a wireless network. The file can be transmitted wirelessly through a variety of different methods, for example, via Bluetooth technology, infrared, or radio frequency.

Once the user has either produced the CD/DVD or transmitted their finished recording 86, the user can end 88 their recording session or purchase additional time 70 and create additional recordings. If the user chooses to purchase additional time 70, then the process may start over again at the top of the exemplary flowchart shown in FIGS. 6A-6B, where the user may have six different options 72 such as recording a bring along instrument, creating digital music, singing and recording karaoke, or bringing in external media and recording on top of the external media, etc. At the end of the auto track merging step 74, if the user is out of recording time, the user may have two options: the user can either purchase additional time 70, or the user can advance to the production step 86 discussed above. As mentioned above, in the production step 86, the finished recording can be downloaded to external digital devices, saved internally for a delayed transfer, burned onto a CD/DVD, or transmitted wirelessly or over the Internet.

If a user selects the recording task 72 of recording vocal only tracks, background music may not be used and the user may proceed to the step of recording and auto track merging 74, as discussed above with respect to recording instruments. After the user has finished recording they can also auto track-merge 74 and review edits 76 and perform all the other steps as mentioned above with respect to recording instruments.

However, if a user selects the create music option 72, the external media option, karaoke option and foreign karaoke options, or freestyle option, the user may proceed to the search select preview step 72a, in which the user may select background music, sounds or songs with which they can sing along. During the search/select/preview step 72a, the user can search a database of songs performed by various artists, and play a sample of a song in order to make a determination if it is the song they want to record. Also, the user can create custom sounds using the system interface 11 by pressing various touch pads displayed on the touch screen. After the user has selected a particular song they want to perform and record 72a, the next step is the recording and auto-track-merging step 74 (the automation of the traditional and intricate multi-tracking process) as discussed above.

When a user has finished recording a track or has finished auto-multi-tracking 74, and the user still has recording time remaining 78, the user can create a new recording or the user can re-create a previous recording 72 if they do not find their original recording satisfactory.

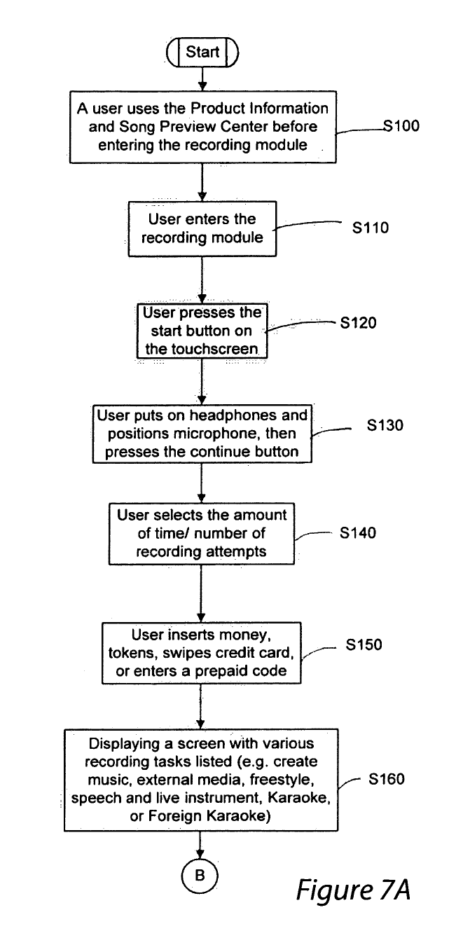

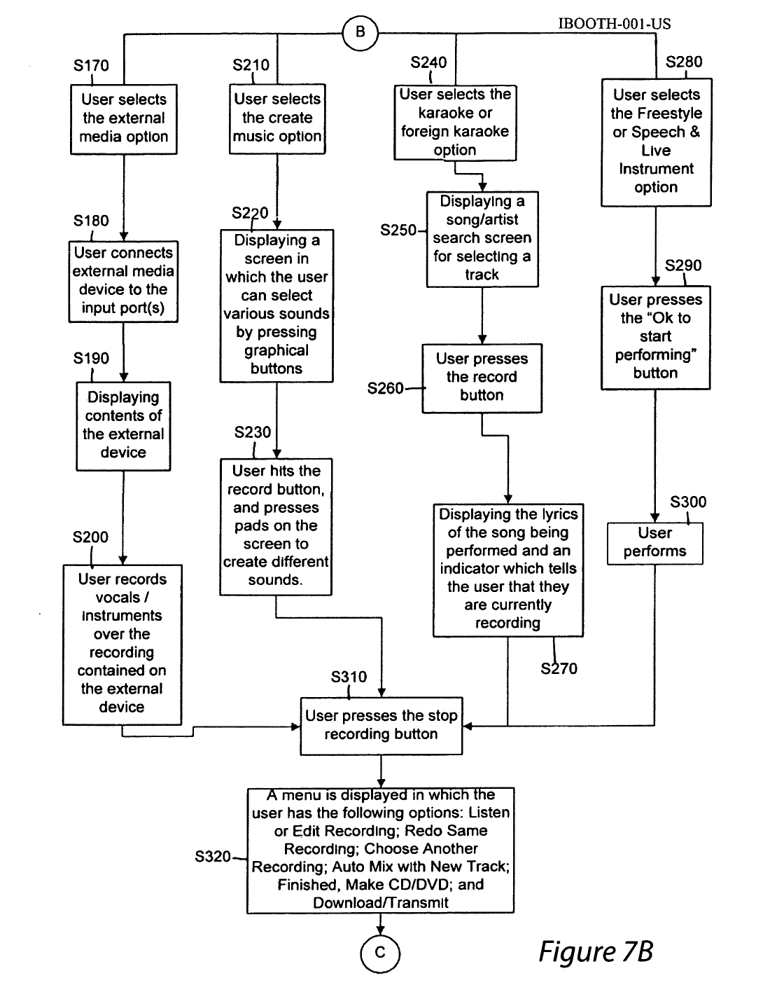

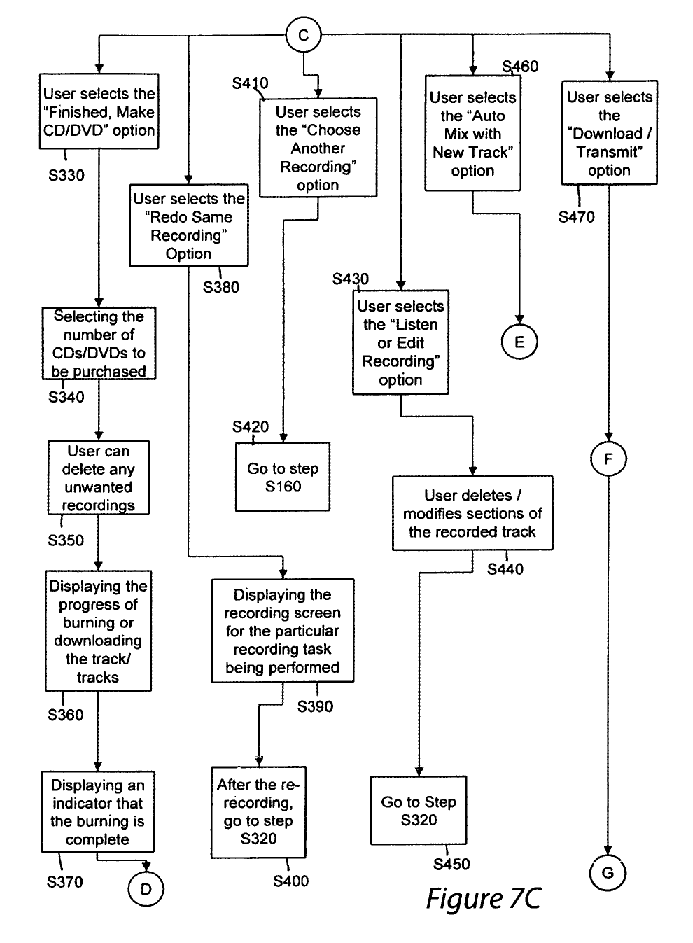

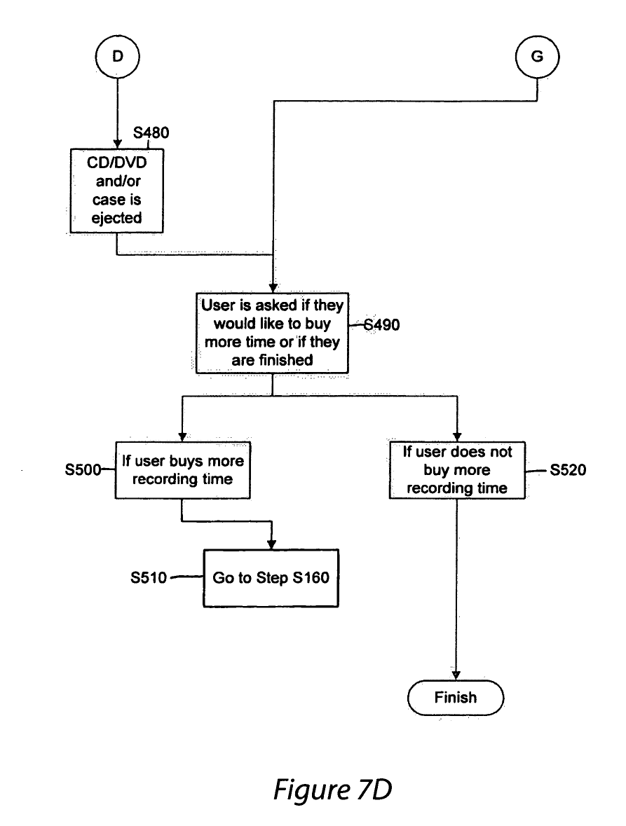

FIG. 7A represents an exemplary flowchart of a top level process where the user may be first introduced to and initiate operation of the facility 1. The process may begin with step S100 where the user may interact with the product information and song preview center 9 prior to entering the facility 1. During step S100 the user can use the external touch screen of the product information and song preview center 9 to preview different types of music and to preview the recording facility 1 capabilities. The information and song preview center 9 can also be connected to headphones, which may allow a user to listen to clips of songs in order to make a song selection before entering the recording module.

A user can also use the song preview center 9 to make preliminary recording selections which can be accessed by the system interface 11 located within the recording module. Specifically, information that is selected and stored via the song preview center 9 can be accessed by the system interface 11 located in the facility 1. Thus, time can be saved by reducing the song selection process and the amount of preliminary steps that may be taken before recording inside the facility 1. Also, by reducing the amount of time a user spends inside the booth, more people are able to use the booth within a given time.

The song preview center 9 may also provide waiting customers with instructional information that can be used to inform the user how to operate the system once they are inside the recording module. The process may then proceed to step S110, where the user enters the recording module. During step S120, the user presses a start button displayed on the touch screen of the system interface 11. Upon touching the start button, the computer processor 43 of FIG. 4 recognizes that the user has initiated a session in the facility 1, and therefore begins a process of interfacing with the user and controlling the auxiliary features previously described in FIG. 4.

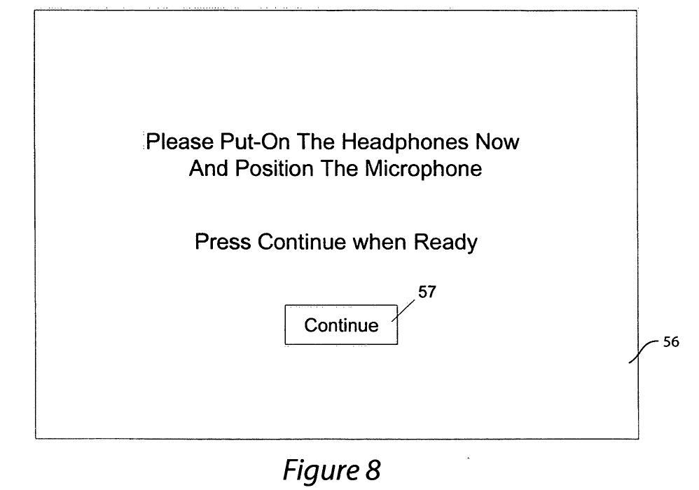

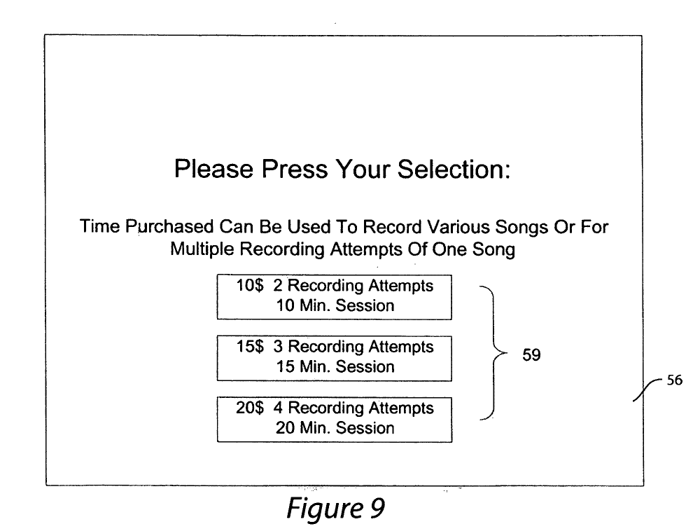

During step S130 the touch screen 56 shown in FIG. 8 may be displayed and the user may position headphones 17, position the microphone 19 to a comfortable level, and may press a continue button 57 on the screen 56. In reply, the touch screen 56, as shown in FIG. 9, may present the user with an amount of time or a number of recording attempts that the user would like to use in step S140. Moreover, the user may select the amount of time when prompted by the touch screen 56, selecting one of recording time buttons 59. The process may then proceed to step S150 where the session can be paid for in a variety of desired methods as discussed previously. These methods may include, but are not limited to, the insertion of currency, tokens, a credit card, entering a prepaid code, logging onto a website, such as PayPal®, or using a proximity detector having the user's credit card information contained therein, to be received by the facility 1 for authorization and ultimate payment.

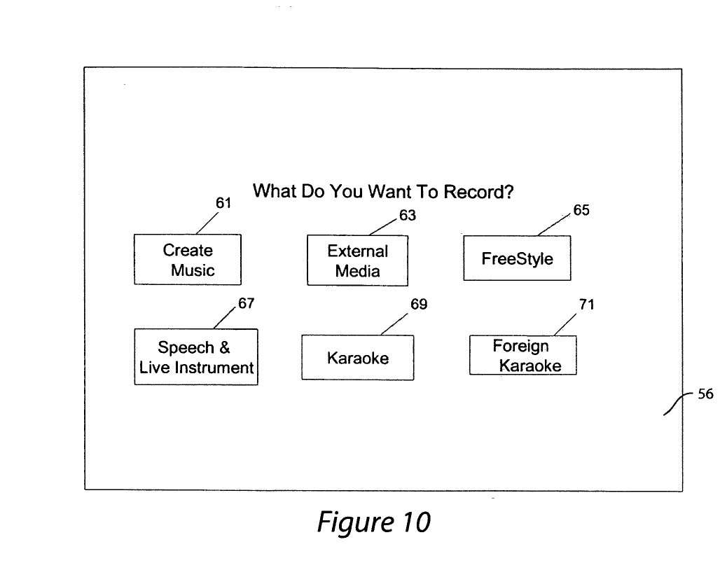

After the facility 1 recognizes that the payment has been made and authorized, the process may then proceeds to step S160 where the user may be presented with instructions, shown in FIG. 10, with various recording tasks that may be presented as options. These options may include, but are not limited to, creating a music file, using an external media, free style, speech, live instrument, karaoke, or foreign karaoke.

After step S160, the process may proceed to selected step S170, S210, S240, or S280. The user may then select various recording tasks they wish to perform. The recording task the user selects may determine the path and processes that the system performs as shown, in FIG. 7B. During step S170, a user may select the external media option, in which case the user may have brought along an external media device such as an MP3 player or other external storage device containing a recording the user wants to use while producing a new recording with the automated recording facility 1. During step S180 the user may connect their external media device to the external device inputs 25 that may be located on the component shell 5 that may be located within the facility 1. These external device inputs 25 can be, for example, USB inputs, firewire inputs, or some other PC or data input device.

Next, during step S190 the system interface 11 may display the contents of the external device to the user or the content of a directory reserved for files that were transferred into the system via the internet/digital/wireless/network etc. The user can then use the system interface 11, e.g., touch screen 56, to select which file stored on the external device (or on the reserved directory for files that were transferred into the system by other means) they wish to use in creating their recording while using the automated recording facility 1. Once the user has selected the file they wish to use, the user may record vocals or instrumentals over the recording contained on the external device. This option may allow the user great flexibility, in that the user can bring in material which may not be available on the database 41, the server 47, or other storage devices accessed by the facility 1. Once the user has finished recording over the recording contained on the external device, the user may stop recording via the system interface 11.

During step S320, a menu may be displayed which the user may be provided several options to manipulate the recording previously performed. The menu can list, for example, an option to listen or edit the recording, an option to recreate the same recording, an option to choose another recording, an option to mix with a new track, an option to make a CD or DVD, an option to download or transmit the recording or any other desired options.

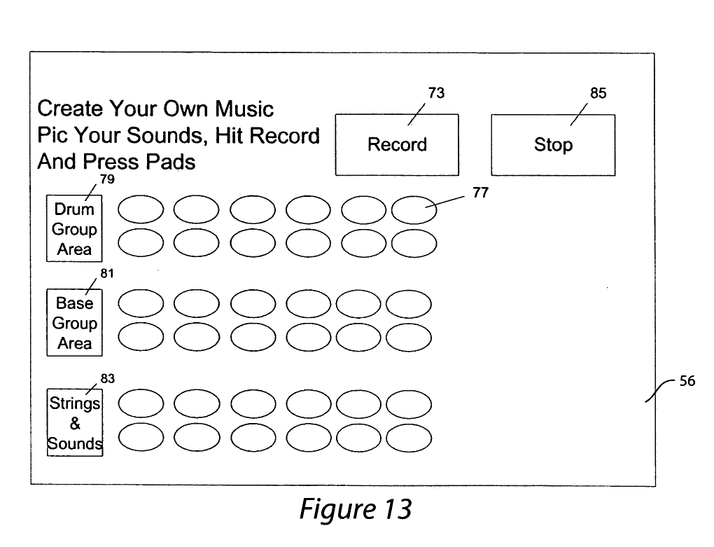

During step S210, if the create music option is selected, a message may be displayed on screen 56 in step S220 which may enable a user to create various sounds by selecting graphical options displayed on the screen 56. The message on the screen 56 may, for example, look like screen 56 shown in FIG. 13. FIG. 13 represents an exemplary screenshot of a graphical user interface screen 56 displayed on system interface 11. During this step the user can select various sounds and create custom sounds electronically by pressing touch pads 77 or otherwise selecting the desired option. Other sound options may include, for example, the drum group area 79 which can include, for example, a drop-down menu including a list of various drum sounds which a user can select. Once the user selects a particular drum sound from the drop-down list displayed in the drum group area 79, the user may then press touch pads 77 displayed next to the drum group area 79 and may be able to hear different notes depending on the touch pad 77 they press. Accordingly, the user can create several drum sounds without bringing a drum set into the recording facility 1.

Also shown in FIG. 13 is a bass group area 81, which may be similar to the previously mentioned drum group area 79 except the bass group area 81 may include a drop-down list including the names of different bass sounds. Similarly, the strings and sounds area 83 may also include a drop-down list including the names of different string instruments and string sounds. Once the user is ready to create their own music they may select a record option 73 and then press the touch pads 77 on the touch screen 56 to create the desired beat and sounds for their recording. When the user is finished recording with the create music option the user may select a stop recording option 85, as shown in FIG. 13, and as described in step S310.

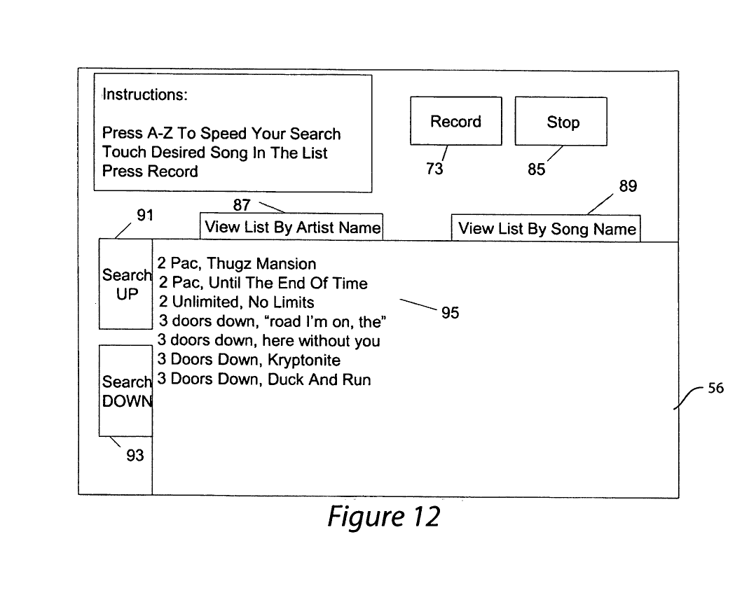

During step S160 a display on screen 56 may be shown, as seen in FIG. 10. The karaoke button 69 or foreign karaoke button 71 may be selected, as in step S240, and a display on screen 56 may aid the user in searching for a song or an artist. During step S250, a display on screen 56 may be shown, as seen in FIG. 12. FIG. 12 illustrates, for example, a particular track that can be searched by either the artist's name or the song name. Songs can also be searched in other ways, for example, by album name, date of album release, or any other desired parameter. If the user wants to search for a song based upon the artist's name, the user may simply select the view by artist button 87 and the track list area 95 may arrange the tracks alphabetically by the artist's name. Alternatively, if the user wishes to view the track list area 95 in the order of the songs listed alphabetically, the user may select the view by song button 91.

Once the view by song button 91 is selected, the track list area 95 may automatically list the tracks in alphabetical order based on the song name, irrespective of the artist's name. This feature may allow a user great flexibility because they can search for a song if they know the song's name, but do not know the artist's name. Also, they can search for a song if they know the artist's name but they do not know the name of the song.

Once the tracks are listed in the order desired by the user, the user can select a track by selecting either the search up button 91 or the search down button 93. The currently selected song may appear highlighted on the screen. When the search down button 93 is selected once, the highlighted track may move to the track below the previously highlighted track. Accordingly, when the search up button 91 is selected, the highlighted track may become the track above the previously highlighted track. Once the user has highlighted the desired track that they would like to perform, the user may select the record button 73 and being performing with the song that they selected. If at any point the user wants to stop the recording, they may simply select the stop recording button 85.

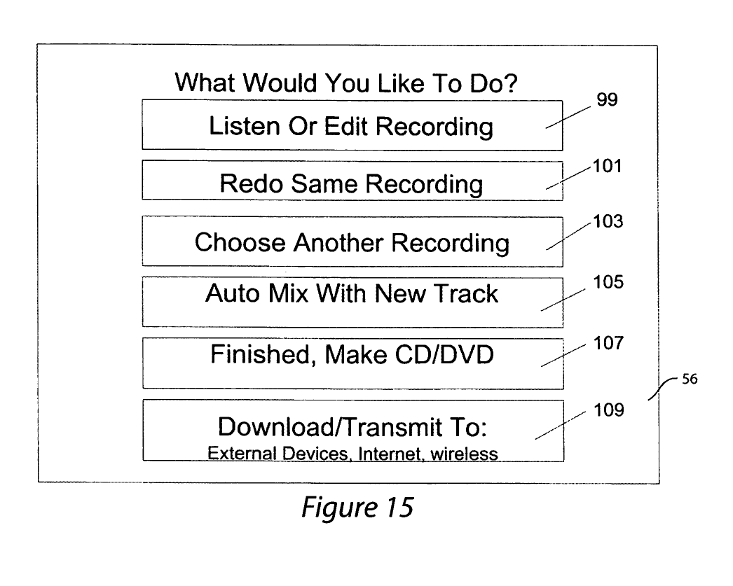

Once the user selects the record button 73 as in step S260, the process may progress to step S270 in which lyrics of the song the user selected may be displayed. The lyrics may be displayed on the system interface 11. When the lyrics are displayed, several words may be displayed at the same time, and when the proper time arises for the user to sing a particular word, the color of the word may change. This feature may allow the singer to sing the lyrics at the proper pace and rhythm. Once the user has completed their karaoke performance, the user may select the stop recording button 85, as shown in step S310. Once the stop recording button 85 is selected, the screen 56, as shown in FIG. 15, may be displayed on system interface 11, and the process may proceed to step S320.

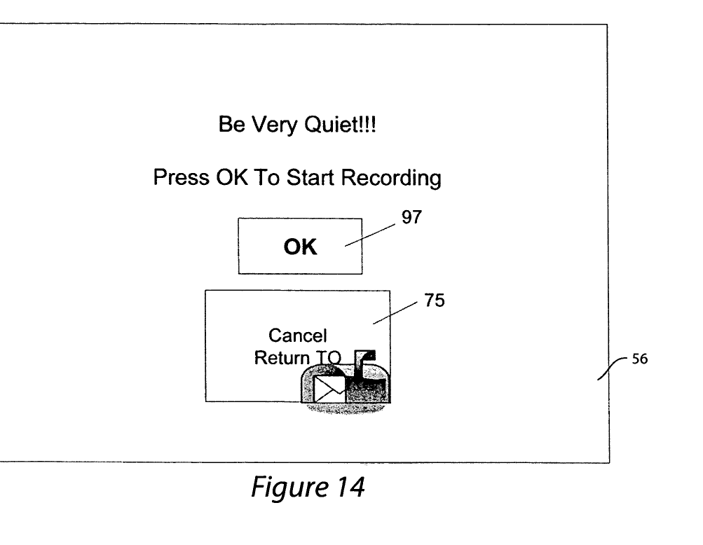

In step S160, when the speech and live instrument button 67 is selected, as shown in FIG. 10, the process may proceed to step S280. In step S280, a screen 56 may be displayed on the system interface 11, as shown in FIG. 14. FIG. 14 shows a screen 56 with two buttons displayed on the screen 56. A first button that may be displayed in FIG. 14 is an okay to record button 97. Once a user selects the okay to record button 97, the recording may begin and the user may start their performance.

The user may be performing a speech, performing a cappella, or performing with an instrument, so there may be no menu to select custom sounds, and no lyrics may be displayed on the system interface 11 at this time. The only thing that may be displayed on the system interface 11 at this time may be an indicator telling the user that they are currently recording. The second button that may be displayed in FIG. 14 is a cancel/main menu button 75.

When a user selects the cancel/main menu button 75, the system interface 11 may displays the screen 56 as shown in FIG. 10 and described in step S160. After the user has selected the okay to record button 97 in step S290, the user may perform their instrumental performance, a cappella performance, speech, etc. as described in step S300. After the user is done performing, they may select the stop recording button 85 in step S310. After the stop recording button 85 has been selected in step S310, a screen 56 as shown in FIG. 15 may be displayed.

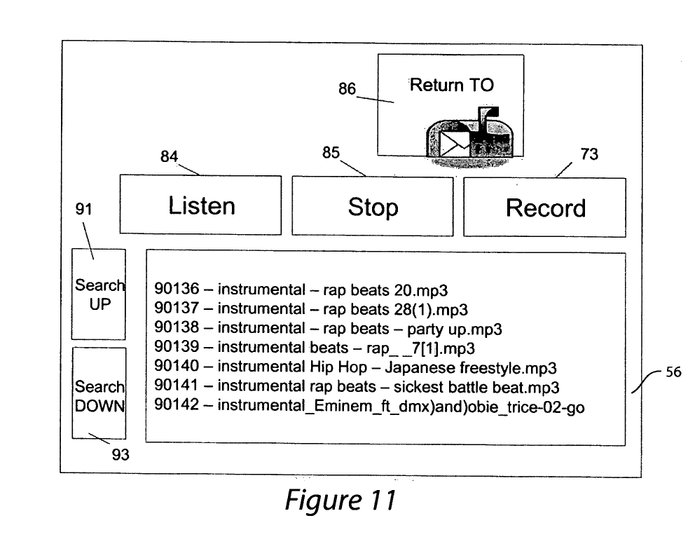

In step S160, when the freestyle button 65 is selected, as shown in FIG. 10, the process may proceed to step S280. In step S280, a screen 56 may be displayed on the system interface 11, as shown in FIG. 11. FIG. 11 may show a screen 56 displaying background beats which a user can select and use during their recording. The screen 56 shown in FIG. 11 may be operated in a similar manner as the screen 56 shown in FIG. 12. A search up button 91 and a search down button 93 may be used to select with which beat the user may wants to preview or record their performance.

Once the user has selected a beat or background music, a listen button 84 can be selected in order to preview the beat. Once the user has selected the beat they wish to record with, the record button 73 is selected and the user begins recording. Once the recording is finished, in step S310, the stop button 85 may be selected. Once the stop recording button 85 is selected on screen 56, as shown in FIG. 15 as displayed on system interface 11, the process may proceed to step S320. Also shown in FIG. 11, is a main menu button 86. When the main menu button 86 is selected the screen 56, as shown in FIG. 10, may be displayed.

In step S320, a menu may be displayed in which the user may have six options, however, other desired options may also be displayed. The options that may be displayed on the screen may include: listen or edit recording; redo same recording; choose another recording; automix with new track; make CD/DVD; and download/transmit to: external devices, Internet, wireless. The user can select one of the options by pressing one of the appropriate buttons on the system interface 11 which could be, for example, a touch screen 56. The first button that may be displayed is a listen or edit recording button 99. A redo same recording button 101, choose another recording button 103, an automix button 105, a make CD/DVD button 107 and a download/transmit button 109 may also be displayed on screen 56 in step S320. When one of these buttons displayed in FIG. 15 is selected, the user may be able to perform the function listed on the button. For example, when the user selects the listen or edit recording button 99, a menu may be displayed in which the user can listen or edit the recording they have just produced.

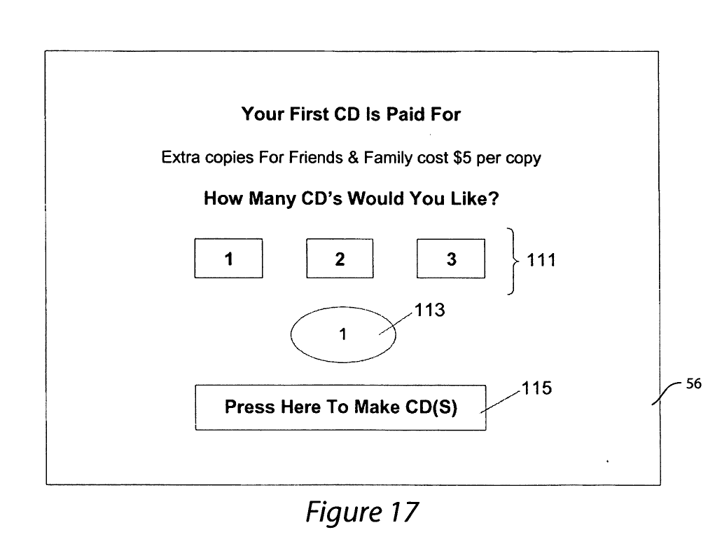

In step S330, as shown in FIG. 7C, a user may have selected the make CD/DVD button 107 from the screen 56 displayed in FIG. 15. Once the make CD/DVD button 107 is selected, a screen 56 as shown in FIG. 17 may be displayed. FIG. 17 may show a CD/DVD number selection area 111 where multiple buttons may be shown which may include consecutive numbers listed on each respective button. For example, as shown in FIG. 17, three buttons may be displayed with each button containing the number of a CD the user may want produced.

The first button may contain the number one, indicating that the user would like one CD or DVD to be produced. The next button shown in the CD/DVD number selection area 111 may be a button with the number two indicated thereon. The last button in the CD/DVD number selection area may have the number three printed on the button to indicate that the user would like three CDs/DVDs to be produced. Also shown in FIG. 17 is a CD/DVD number display area 113 indicating the number of CDs that the user may have selected within the CD/DVD number selection area 111. For example, if a user selected the number two button in the CD/DVD number selection area, the number two may be displayed in the CD/DVD number display area 113. This may allow the user to confirm which button in the CD/DVD number selection area 111 was selected. Once the desired number is displayed in the CD/DVD number display area 113, the user may select a make CD button 115 and the computer processor 43 may send a signal to the CD/DVD producer 37 indicating the desired number of CDs/DVDs to be produced.

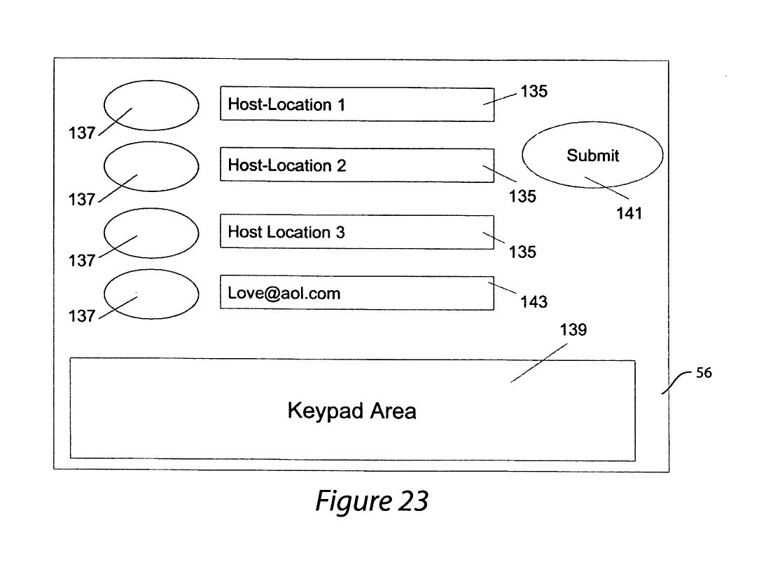

Once the desired number of CDs/DVDs to be produced and purchased is selected in step S340, and before the CDs or DVDs are actually produced, a screen 56 as shown in FIG. 23 may be displayed. The screen 56 shown in FIG. 23 may allow a user to delete any unwanted recordings before burning these recordings to a CD, DVD or other recordable medium. For example, if a user created multiple recordings during one recording session, and only one recording was satisfactory to the user, the user could delete all unwanted recordings and only bum the desired recording to the recordable medium. This way, the user can have a copy of the finished and desired recording.

Prior to a user manipulating the screen 56, as shown in FIG. 23, a user may select from a list of recordings displayed on a screen. Once a user selects a particular recording, the screen as shown in FIG. 23 may appear. With the selected recording the user may have three options, as shown in FIG. 23. An option may be selected by the user by selecting one of following buttons (or another button if additional options are provided): a play button 117, a stop button 119, and a delete button 121.

When the user presses the play button 117, a sampling of the recording, or the entire recording, may be played and the user can determine if they want to keep this recording or if they would like to delete this recording prior to burning it on a CD, DVD, or other recordable medium. The stop button 119 may stop the sampled recording from being played after the user has pressed the play button 117. The delete button 121 may delete the selected recording. Once the user has disposed with the selected recording in the manner they desire, the user can press the continue button 123 and go back to the previous screen, which is not shown in the figures, and select another recording that was produced during the particular recording session and either keep or delete the recording. Once the user has deleted or kept the recordings they wish, the user can press a return to main menu button 125 and the screen 56, shown in FIG. 15, may be displayed.

Once the user has deleted any unwanted recordings as described above, the process may proceed to step S360. In step S360, a screen 56 may be displayed which may indicate the progress of burning a CD, DVD, or other recordable medium or the progress of downloading a recording or recordings to a destination. In step S370, a screen 56 may be displayed that indicates that the burning or downloading of the recording is complete. In step S480, the produced CD or DVD may be output by the CD/DVD dispenser 29. Also during step S480, if a CD or DVD case has been purchased, the case dispenser 31 may eject the case at this time. Next, in step S490, a screen 56 may appear where the user may be inquired if they would like to buy more recording time or if they are finished with their recording session. In step S500, if the user wants to buy more recording time, the process may proceed to step S510. In step S510, the next screen 56 that may be displayed on the system interface 11 is the screen 56 displayed in step S160, i.e. FIG. 10. In step S520, if the user does not want to buy more recording time, the recording process may be over and the user may exit the automated recording facility 1.

If a user selects the redo same recording button 101, as shown in FIG. 15, and as described in step S380, a screen 56 may be displayed in which the user can record the particular recording task they were previously performing. That is, in step S390, if the user was previously creating a recording with instruments, and they wanted to redo this recording, the screen displayed is the same screen displayed when a user is recording with bring along instruments. Another example is if a user would like to redo a karaoke performance, the screen 56, as shown in FIG. 12, may be displayed in step S390. In step S400 after the user has re-recorded, the screen 56 in FIG. 15 may displayed, and the process may proceed to step S320.

In step S320, if the user selects the choose another recording button 103, displayed in FIG. 15, as in step S410, the process may proceed to step S420. In step S420, the screen 56 displayed in FIG. 10 may be displayed. That is, the user may have the option of creating a different type of recording (i.e., create music, external media, freestyle, speech and live instrument, karaoke, and foreign karaoke).

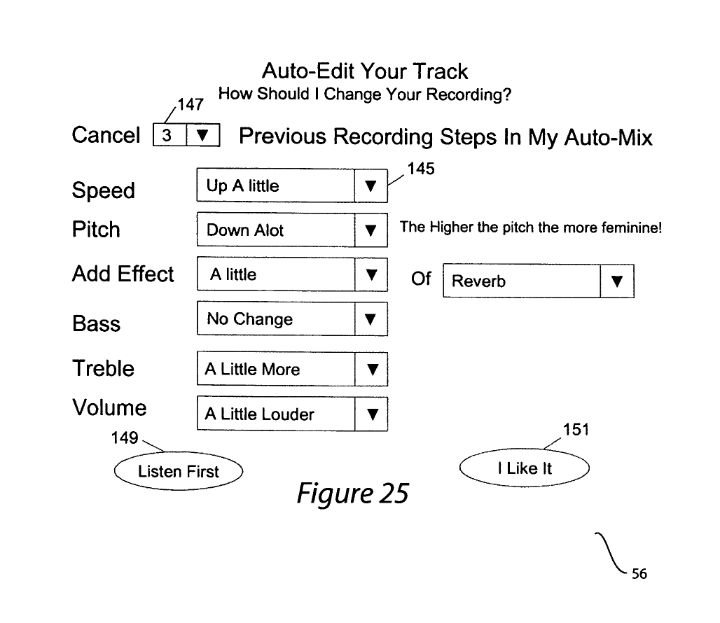

In step S430, if the user selects the listen or edit recording button 99, as displayed in FIG. 15, the user may be given the ability to listen to their previously recorded track and edit their recording. However, the system may present a simplified edit-screen suitable for the average user. In step S440, a user may be able to edit their recording by navigating a screen 56, as shown in FIG. 25, displayed on the system interface 11. Examples of editing features that can be performed are, for example, erasing sections of a track, adjusting the vocal pitch correlation of a track, adjusting the bass in a track, the treble, or the midrange.

Using the auto-edit screen in FIG. 25, users may alter their previously recorded tracks. The auto-edit screen may control various editing features that utilize digital algorithms in order to edit or modify a recording. The auto-edit screen may use simple settings and commands such as “change a little” and “speed up a lot,” as opposed to using complex ratios and percentages that are usually associated with utilizing such features. Various editing parameters such as speed, pitch, reverberation, bass, treble, volume, etc. may be adjusted by means of a drop-down menu 145 or by some other desired method. Other desired editing parameters are also possible.

In addition, the auto-edit screen, as shown in FIG. 25, may allow users to revert back to a previous recording and to cancel multiple recorded layers in a merged composition. A user can also revert back to a previous recording by selecting the number of recording steps they want to cancel by using a recording cancellation menu 147. The recording cancellation menu 147 may contain a drop-down menu listing consecutive numbers, indicating the amount of recording steps the user wants to undo (i.e. revert back to previous recording versions). For example, if a user selects the number two from the recording cancellation menu 147, the last two recording steps may be erased and the user can then edit or multi-track the recording as it was prior to the last two recording steps. The user may also preview their changes to the recording before allowing such changes to take place, by selecting an edit preview button 149. Once the user is satisfied with the edits they have made, they may select an edit save button 151.

For every recording attempt, auto-merge, or edit change, the computer processor 43 may save a copy of the prior track without the applied changes, and save a copy of the track with the applied changes or recorded additions. As such, the system may provide the user with a simple way to cancel changes in his track, edit tracks, redo changes, and create multi-layered recording compositions without having to perform complex recording/editing processes such as the ones used in professional recording studios. It is also possible that other more advanced editing features can be simplified for the average user and carried out by the automated recording facility 1 during the editing process.

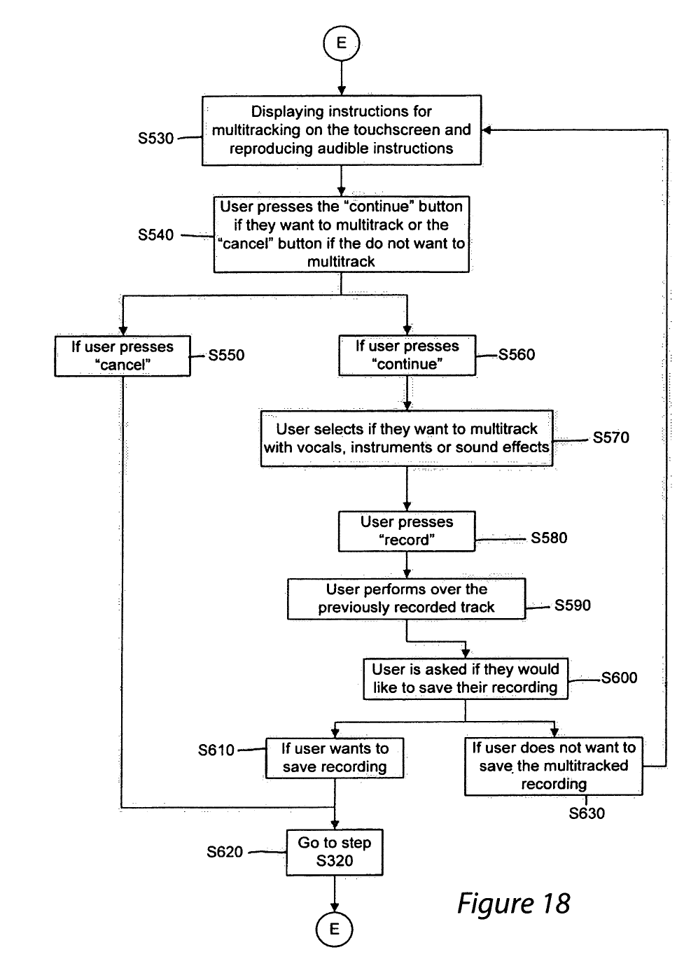

After the user has finished listening to the recording or editing their recording, they may proceed to step S450. In step S450, the screen 56 in FIG. 15 may be displayed in accordance with step S320. In step S460, a user may select the Auto Mix button 105 that is displayed in FIG. 15, which may carry out the automated merged-multi-track functions that automate the multi-tracking process. The multi-tracking process is described in the exemplary flowchart in FIG. 18.

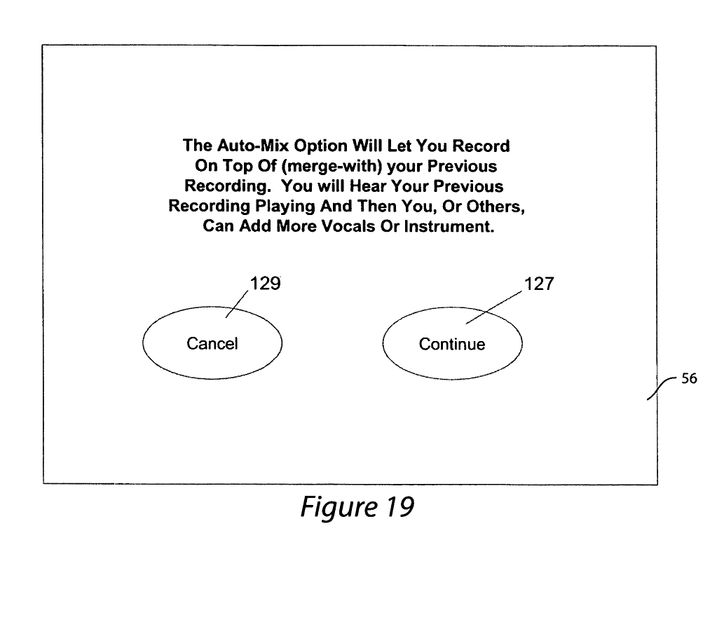

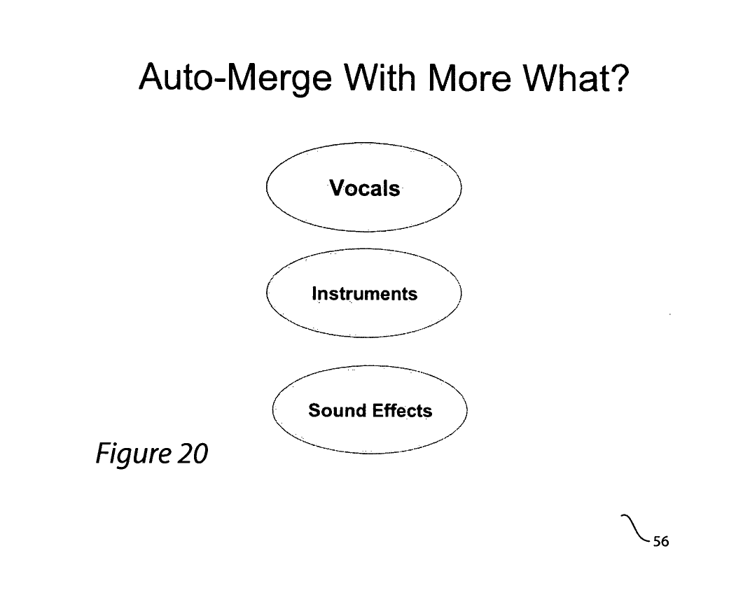

As shown in FIG. 18 step S530, a screen may be displayed (not shown) that may provide instructions and information for the auto-multi-track-merge (auto mix) option on the system interface 11. Also, in addition to displaying information/instructions, just as in any other step of using this system, audible instructions may be reproduced by the headphones 17 and/or speakers that may be located inside the automated recording facility 1. Next in step S540, the screen 56 as shown in FIG. 19 may be displayed. The screen 56 shown in FIG. 19 may contain two buttons: a CONTINUE button 127 and a CANCEL button 129. When the user is ready to use the auto-multi-rack-merge function, the user may select the CONTINUE button 127 on the system interface 11, as in step S560. Next, in step S570, the screen 56 in FIG. 20 may be displayed where the user can select the type of media with which they want to auto-merge their previous recording. For example, in FIG. 20 three options may be presented to the user (such as, but not limited to, vocals, instruments, and sound effects). Once the user selects one of the three options, the system interface 11 may display a recording screen 56 (e.g. FIG. 13, FIG. 14) for the chosen type of recording as described above.

Next, in step S580, the user may select the appropriate record button and the user may hear their previous recording playing in the background while they add new vocals or instruments or any other type of music on top of their previous recording. Multi-tracking is a professional studio term that describes a method of producing a song which is composed of various different layers of music. Typically, in order to perform a multi-tracking process, a studio engineer, or an individual with prior knowledge of a multi-tracking process needs to be present in order to record and then mix/merge separately recorded tracks into one track with the use of a soundboard or intricate recording-studio software tools. However, with the system, the computer processor 43 (using the system's custom software) may automatically perform the multi-tracking process via the auto-multi-track-merge function and a user with ordinary knowledge can simply trigger this function by selecting a button on the touch screen and can emulate the result of a complex multi-tracking process (the creation of a multi-layered composition).

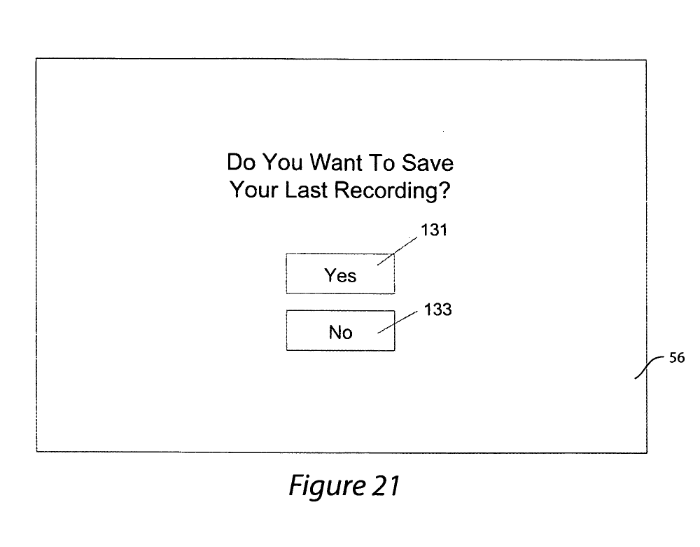

In step S590, the user may perform over their previously recorded track. Next in step S600, and as shown in FIG. 21, a screen 56 may be displayed where a user may be asked if they would like to save their recording. In step S610, if the user wants to save their recording, they can select a YES button 131 and the process may proceed to step S620. In step S620, the process may proceed to step S320 and the screen 56 in FIG. 15 may be displayed. However, if the user does not want to save their multi-tracked recording, in step S630, the user may select a NO button 133 and the process may proceed to step S530. In step S530, a screen may be displayed again providing instructions for multi-tracking on the touch screen 56 and audible instructions may again be reproduced for the user. Accordingly, the user can then redo their multi-tracked recording off the original (or previously saved) recording.

At the conclusion of each automated recording process the user may proceed back to the same screen that triggered the process and, again, can listen, auto-edit the recording, trigger this process again, or begin a new composition. As previously described, with each request for a new recording, the system displays a screen that asks the user whether or not to keep the last recording. In a multi-merged composition, the last recording is the last recorded addition made by the user. The recording facility 1 may keep a copy of all recording attempts. Thus, eliminating the most recently merged-recording addition or additions may be easily performed by selecting the YES button 131 or the NO button 133 shown in FIG. 21. In the event that the user desires to eliminate multiple merged-recording-additions, as opposed to just the last recording, the auto-edit screen as shown in FIG. 25 and described above may become helpful in providing the user with such functionality.

In step S540 shown in FIG. 19, the user may not want to proceed with the multi-tracking function, the user may simply press the CANCEL button 129 as shown in FIG. 19 and the process may proceed to step S620. In step S620, the process may revert to step S320 and the screen 56, as shown in FIG. 15, may be displayed. From this screen, the user may then have the option of listening or editing their recording, redoing their recording, choosing another recording, multi-tracking again with a new track, recording onto a CD, DVD or other recordable medium, or download and transmitting their recording to an external device, etc.

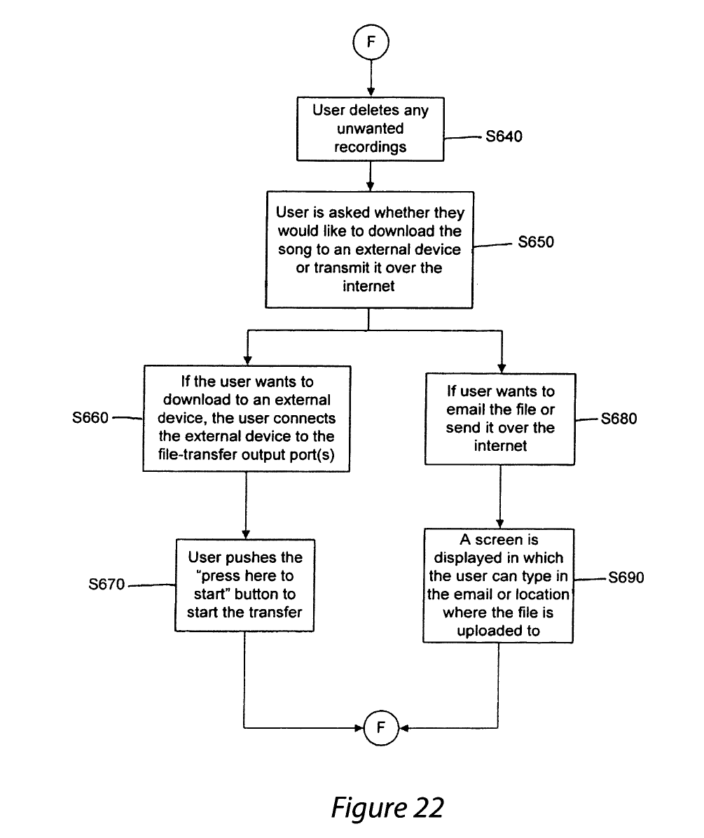

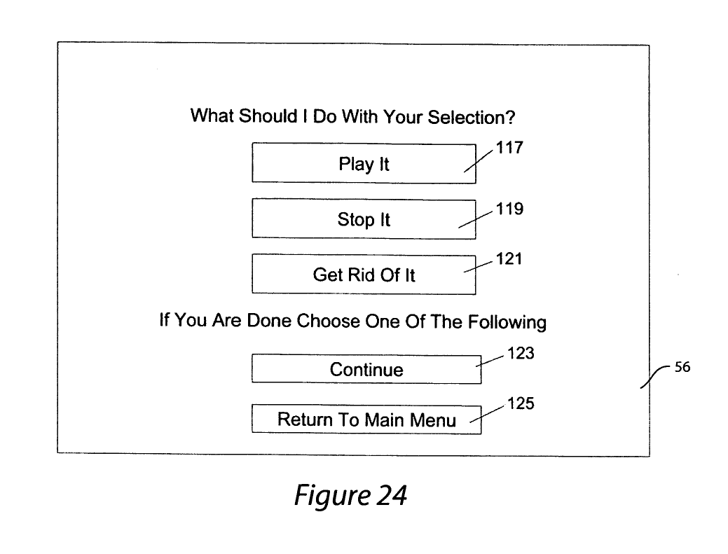

FIG. 22 shows an exemplary flowchart describing a download and transmitting option. In FIG. 7C, when a user in step S470, selects the download/transmit button 109 from the screen 56 displayed in FIG. 15, the first screen that may be displayed may be the screen 56 shown in FIG. 24. The user can manipulate this screen as described above. Thus, in step S640, the user can delete any unwanted recordings before transmitting or downloading their recordings over the Internet or to an external device. In step S650, a screen may be displayed that asks a user if they would like to download their recording to an external device or transmit it over the Internet. In step S660, if the user wants to download the recording to an external device such as an MP3 player, for example, the user may connect their external device to the external device inputs 25. Then in step S670 a screen may be displayed that prompts the user to select a button in order to start the transfer of the recording from the automated recording facility 1 to the user's external media device.

However, if, as in step S680, the user wants to e-mail the file or send it over the Internet, a screen 56 may be displayed, as shown in FIG. 23. Thus, in step S690, the screen 56 as shown in FIG. 23 may be displayed. In FIG. 23, four destination location boxes 135 may be shown, each may contain a different location to which a user's recording can be transmitted. For example, these destination location boxes can include the location of a server or could include an e-mail address. A user can insert an e-mail address to which they would like to transmit their recording, by using a keypad area 139 as shown in FIG. 23. The keypad area 139 may include, for example, an alpha-numeric keypad containing both letters, numbers and other common characters that a user can select via a touch screen.

A user may select a particular destination by selecting one of multiple SELECT buttons 137 that may be located adjacent to the destination location boxes 135. Thus, by selecting the SELECT button next to a particular destination location box, the user may select the destination recited inside the particular destination location box 135. Again, if the user wants to transmit to an e-mail address, the user may select the SELECT button 137 adjacent to the e-mail input field 143 and then may be able to use keypad area 139 to type in the desired destination e-mail address.

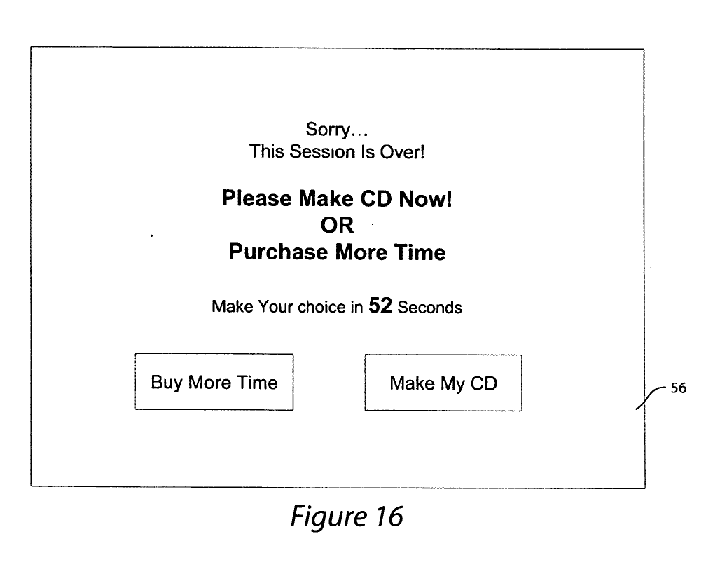

Once the user has selected the appropriate destination with the SELECT button 137, the user may select a SUBMIT button 141 and the recording can then be transmitted to the selected destination. After step S690, the process may proceed to step S490 as shown in FIG. 7D. In step S490, a screen 56, as in FIG. 16 may be displayed asking the user if they would like to buy more recording time or if they are finished recording. If the user desires to buy more recording time as in step S500, the process may proceed to step S510. In step S510, the process may proceed to step 160 and the screen 56, as shown in FIG. 10, may be displayed. However, if as in step S520, the user does not want to buy more recording time, the recording process may be terminated and the user may have finished using the automated recording facility 1. Thus, the user can exit the facility 1 via the main door 33 and allow another individual to use the recording facility 1.

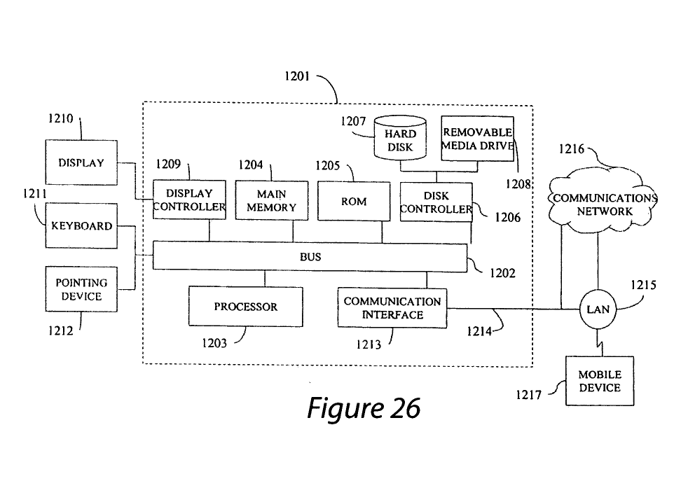

FIG. 26 illustrates an exemplary computer system 1201 upon which an embodiment of the automated recording facility 1 may be implemented. The computer system 1201 may include a bus 1202 or other communication mechanism for communicating information, and a processor 1203 coupled with the bus 1202 for processing the information. The computer system 1201 may also include a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203.

In addition, the main memory 1204 may be used for storing temporary variables or other intermediate information during the execution of instructions by the processor 1203. The computer system 1201 may further include a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 may also includes a disk controller 1206 coupled to the bus 1202 that can control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system may include input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 may perform a portion or all of the processing steps of the recording process and automated recording facility 1 in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the automated recording facility and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the automated recording facility 1 may include software for controlling the computer system 1201, for driving a device or devices for implementing the automated recording facility 1, and for enabling the computer system 1201 to interact with a human user (e.g., print production personnel). Such software may include, but is not limited to, device drivers, operating systems, development tools, and applications software. Such computer readable media further includes the computer program product of the automated recording facility 1 for performing all or a portion (if processing is distributed) of the processing performed in implementing the automated recording facility 1.

The computer code devices of the automated recording facility 1 may be any interpretable or executable code mechanism, including but not limited to scripts, interpretable programs, dynamic link libraries (DLLs), Java classes, and complete executable programs. Moreover, parts of the processing of the automated recording facility 1 may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the automated recording facility 1 remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave.

The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

The foregoing description and accompanying drawings illustrate the principles, preferred embodiments and modes of operation of the automated recording facility 1. However, the permit application and issuance system should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the permit application and issuance system as defined by the following claims.

What is claimed is:

1. A recording apparatus comprising:
a booth including:
an interior space fully enclosed by an exterior shell;
a processor enclosed within the booth that communicates with an audio recording system;
a hard drive connected to the processor;
at least one audio device connected to an input connected with the processor;
a system interface connected with the processor that receives selected input from a user to control the audio recording system; and
an output.

2. The recording apparatus of claim 1, wherein the booth is portable.

3. The recording apparatus of claim 1, wherein the exterior surface of the exterior shell includes at least one electronic display screen.

4. The recording apparatus of claim 1, wherein the exterior shell comprises:
an electronic screen that is transparent and allows for visibility between a location outside of the booth and a location within the interior of the booth.

5. The recording apparatus or claim 1, wherein the audio device is a microphone.

6. The recording apparatus or claim 1, wherein the audio device is a musical instrument.

7. The recording apparatus of claim 1, further comprising:
a data storage device that receives the output from the recording apparatus.

8. The recording apparatus of claim 7, further comprising:
a dispenser that dispenses the data storage device to the user.

9. The recording apparatus of claim 1, further comprising:
a data link that facilitates a transfer of the output to a remote server.

10. The recording apparatus of claim 1, further comprising,
an external display connected to the processor that displays options and instruction for the user in order to facilitate the use of the audio recording system.

11. The recording apparatus of claim 1, further comprising,
a video camera to record a video of the user and that stores the video on the hard drive.

12. The recording apparatus of claim 1, further comprising,
a currency acceptor connected to the processor that accepts currency from the user.

13. The recording apparatus of claim 1, further comprising,
a preview center mounted on an exterior surface of the exterior shell and connected with the processor that displays booth operating options and instructions.

14. The recording apparatus of claim 1, further comprising,
a multi-track recording program stored on the hard drive and communicable with the processor.

15. The recording apparatus of claim 1, further comprising,
a computer network connecting the processor with a computer access port at a location separate from the portable booth.

16. A method of recording a performance comprising:
entering a booth;
selecting a musical work using a system interface;
recording a first audio performance;
storing the first audio performance on a hard drive;
recording a second audio performance;
storing the second audio performance on the hard drive;
editing the first and second audio performances using the system interface; and
merging the first and second audio performances with the selected musical work using a track merging program stored on the hard drive.

17. The method of recording of claim 16, further comprising,
transferring the merged audio performances onto an external data storage device.

18. The method of recording of claim 17, further comprising,
dispensing the external data storage device.

19. The method of recording of claim 16, further comprising,
performing the first audio performance through the use of a microphone within the booth, accompanied by the selected the selected musical work.

20. The method of recording of claim 19, further comprising,
recording a video of the first audio performance using a video camera mounted with the booth.

21. The method of recording of claim 16, further comprising,
performing the second audio performance through the use of an instrument, accompanied by the selected the selected musical work.

22. The method of recording of claim 16, further comprising,
submitting a fee to a currency acceptor connected to the system interface.

23. The method of recording of claim 16, further comprising,
downloading the merged audio performance onto a network; and
sending the downloaded audio performance via the network to a location removed from booth.

24. The method of recording of claim 16, further comprising,
creating a digital instrumental musical track using prerecorded instrumental effects stored on the hard drive using the system interface; and
merging the created digital instrumental track with the first audio performance using a track merging program stored on the hard drive.

25. The method of recording of claim 16, further comprising,
transferring a musical work from an external storage device to the hard drive; and
merging the transferred musical work with the first audio performance using a track merging program stored on the hard drive.
